(19) United States
(12) Patent Application Publication
(10) Pub. No.: US 2003/0055824 A1
(43) Pub. Date: Mar. 20, 2003

(54) Distributed personalized genetic safe

(76) Inventor: Andrea Califano, New York, NY (US)

Correspondence Address: ROPES & GRAY, ONE INTERNATIONAL PLACE, BOSTON, MA, 02110-2624, US

(21) Appl. No.: 10/187,320

(22) Filed: Jun. 28, 2002

Related U.S. Application Data
(60) Provisional application No. 60/323,243, filed on Sep. 19, 2001.

(51) Int. Cl. G06F 7/00

(52) U.S. Cl. 707/9

(57) ABSTRACT

A system and method for maintaining an individual's privacy such that only he could authorize the use of his genotype data. The systems and methods described herein discuss the use of a system that may act as a personal electronic safe to allow any individual to store his or her medical records, including genotype data and associated tissue sample management data, on a personal computer or on a remote site linked to the Internet. The safe, in one practice, allows one's own medical information to be used solely for the purposes authorized by the individual, or an agent or guardian of that individual. This includes the management of the individual's own health records as well as the use of stored information for medical purposes. This safe's encryption mechanisms and certificates may allow only designated parties to access the data. The encryption mechanisms and certificates restrict the use of the data in studies through software that is certified to be able to analyze the data without releasing it in any form that would violate the individual's identity.

### REFERENCE TO RELATED APPLICATIONS

This application relates to earlier filed U.S. Provisional Application Serial No. 60/323,243 entitled “Distributed Personalized Genetic Safe” and identifying Andres Califano as inventor, the contents of which are incorporated by reference herein.

### FIELD OF THE INVENTION

The invention is directed to systems and methods for accessing data while maintaining the privacy of the source of the data.

### BACKGROUND

In the absence of a specific link to an individual's identity, medical phenotypic data (genetic data, in particular) have been, thus far, considered non-identified information. As such, de-identified gene expression data sets obtained under informed consent have been posted on the Internet for public use. Fingerprint data, in contrast, is considered identified information and cannot be released without the express consent of the individual.

This is a paradox that will be short-lived as an individual genome contains on average several million unique genetic markers, including Single Nucleotide Polymorphisms (SNP), Microsatellites, Macrosatellites, etc.—making them, in combination, more discriminating than the ridge and minutiae patterns in fingerprints. This paradox will need to be addressed to prevent critical individual information from being exposed.

Protection of genetic information is crucial due to the unchanging nature of genotypic data. That is, for the majority of individuals, the set of markers that uniquely characterize an individual are statically assigned at birth and are conserved in the offspring. Therefore, even if at the moment it would be difficult to assign an identity to a set of individual markers, this may become a trivial and accessible procedure in a small number of years, due to the advent of cheap genotyping procedures coupled with the availability of large databases of genetic information.

Consider, for instance, the following scenario: Suppose that a de-identified database of genotyping data were available. Suppose this database included a large segment of the population and that each record contained one million SNPs for each individual. By algorithmic means it would be easy to identify a small set of N markers which would be perfectly discriminatory. That is, no two individuals in the database would share the same set of N markers. For practical purposes, N could be as small as 50. Then, by genotyping those N markers from any individual's biological sample and by matching them against the database, one would be able to identify any individual of interest and, furthermore, access their full genotypic record.

To avoid unauthorized genotypic mapping, it would be advantageous for individuals to have more control over how and when their genotype data is used.

### SUMMARY OF THE INVENTION

The invention, among other things, includes a system and method for maintaining an individual's privacy such that only he could authorize the use of his genotype data. The systems and methods described herein discuss the use of a system that may act as a personal electronic safe to allow any individual to store his or her medical records, including genotype data and associated tissue sample management data, on a personal computer or on a remote site linked to the Internet. The safe, in one practice, allows one's own medical information to be used solely for the purposes authorized by the individual, or an agent or guardian of that individual. This includes the management of the individual's own health records as well as the use of stored information for medical purposes. This safe's encryption mechanisms and certificates may allow only designated parties to access the data. The encryption mechanisms and certificates restrict the use of the data in studies through software that is certified to be able to analyze the data without releasing it in any form that would violate the individual's identity.

More particularly, the invention includes systems for controlling access to genetic and medical data, comprising a database for storing an encrypted data file having information representative of genetic and medical data and being associated with an individual, an access control processor for allowing the individual to restrict access rights that an entity may have to the encrypted data file associated with the respective individual, and a message processor controlled by the access processor for delivering a message from the entity to the individual, whereby the individual can receive messages from an entity without the entity knowing the identity of the individual.

2. Optionally, the access control processor includes a mechanism or software process for enforcing access restriction controls over the access that the individual may have over the encrypted data file. The access control processor may include a process for preventing the individual to access data stored within the encrypted data file. Further, the message processor may include a process for storing a message provided by an interested party into a database for later retrieval by the individual. Note the interested party may include an administrative service that supports the banking process described herein, a third party entity, or even the individual themselves. The message processor may include a notification processor for communicating to the individual that a message is waiting for the individual. The notification processor may include a portal that may be accessed by the individual to determine whether a message is waiting for the individual. Further the notification processor may include a mail server for sending an e-mail notification to the individual. Optionally, the notification processor may include a processor for prompting the encrypted data file to notify the respective individual of a waiting message.

In a further optional embodiment, the system may include access controls that employ digital certificates for controlling access to the encrypted data file, that employ password verification systems for controlling access of to the encrypted data file.

In a further aspect the invention will be understood to include systems for allowing a individual to control access to genetic data, comprising a database system for allowing a individual to create and store a encrypted data file having information representative of genetic data and being associated with a individual and having a set of access rules representative of the parties that may access the genetic information, a web portal for allowing authorized access to the database, and having an access control processor for employing the set of access rules to control access by entities to the encrypted data file associated with the respective individual, and a message processor for delivering a message from an entity to the individual, whereby the individual can receive messages from an entity without the entity knowing the identity of the individual.

In a further aspect the invention may be understood to include a process for controlling access to genetic data, comprising creating an encrypted data file being associated with a individual and having information representative of genetic and medical data and, allowing the individual to establish access rights that an entity may have to the encrypted data file associated with the respective individual, and providing a message processor capable of delivering a message from a third party to the individual, whereby the individual can receive messages from a third party without the third party knowing the identity of the party.

In yet another aspect the invention may be understood to provide systems for controlling access to genetic and medical data, comprising a plurality of data processors each having a storage device for storing the genetic and medical data of an individual in an encrypted format, a registry having storage for a plurality of pointers, a pointer being representative of a respective one of the data processors, and a query process for allowing an entity to enter a query representative of a request for information and being capable of transmitting the query to the plural data processors for searching data in the respective encrypted data files.

Optionally, the registry includes for each pointer, storage for messages being left by the entity. The messages may include educational material, promotional literature, clinical study information and informed consent forms.

Optionally, the system may also include an audit process for creating a log of the entities that have accessed a particular encrypted data file.

Other embodiments and practices will be apparent to those of skill in the art.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts a functional block diagram of one system according to the invention;

FIG. 2 depicts a data flow diagram of one process according to the invention;

FIG. 3 depicts a further data flow diagram illustrating the delivery of information to a user; and

FIG. 4 depicts a functional block diagram of a system according to the invention.

### DETAILED DESCRIPTION OF CERTAIN ILLUSTRATED EMBODIMENTS

The invention is directed to systems and methods for allowing an individual to grant or refuse to grant authorization to use certain data, and, if granted, allow the use of data without releasing the identity of the individual.

More particularly, the systems and methods described herein include systems and methods for controlling authorization to use or access data associated with a particular user. The data may include medical data, biological data, genetic data, demographic data, identity data, or passwords or other types of keys for accessing biological samples, results of medical tests, or other information. In one embodiment, as we describe in greater detail herein after, this system includes a plurality of distributed encrypted data files wherein each data file provides a monad that is associated with a particular user. One practice the electronic safe is implemented as a computer process and encrypted data file stored on a client PC. Each user may store data on their own client PC, therefore providing a distributed set of electronic safes. Each user may employ the process operating on the client PC to access a registry or directory. Through the directory the user may register their safe with system and may indicate the degree and kinds of authorization the user will provide with respect to the encrypted data. As will be described herein, a physician, clinician, pharmaceutical company, researcher, or other person or entity may access the directory and, depending on the rights granted to that entity, may review data registered by the users with the system. In this way, the user can provide controlled authorization to review or access medical, genetic, biological, or other data associated with the user. A physician, clinician, or other entity that has, in one embodiment, appropriately certified software may access the directory and review this data without ever determining or knowing the actual identity of the user that provided the data. As such the systems and methods described herein provide a platform for allowing users to expose medical, genetic, biological, and other information to a group of authorized third parties, without the risk of a third party determining the identity of the user. Thus the user is able to maintain privacy while at the same time allowing their information to involved in studies, research or other activities that may be beneficial to that user or others. Moreover, the systems described herein allow a user to anonymously receive relevant data and/or information.

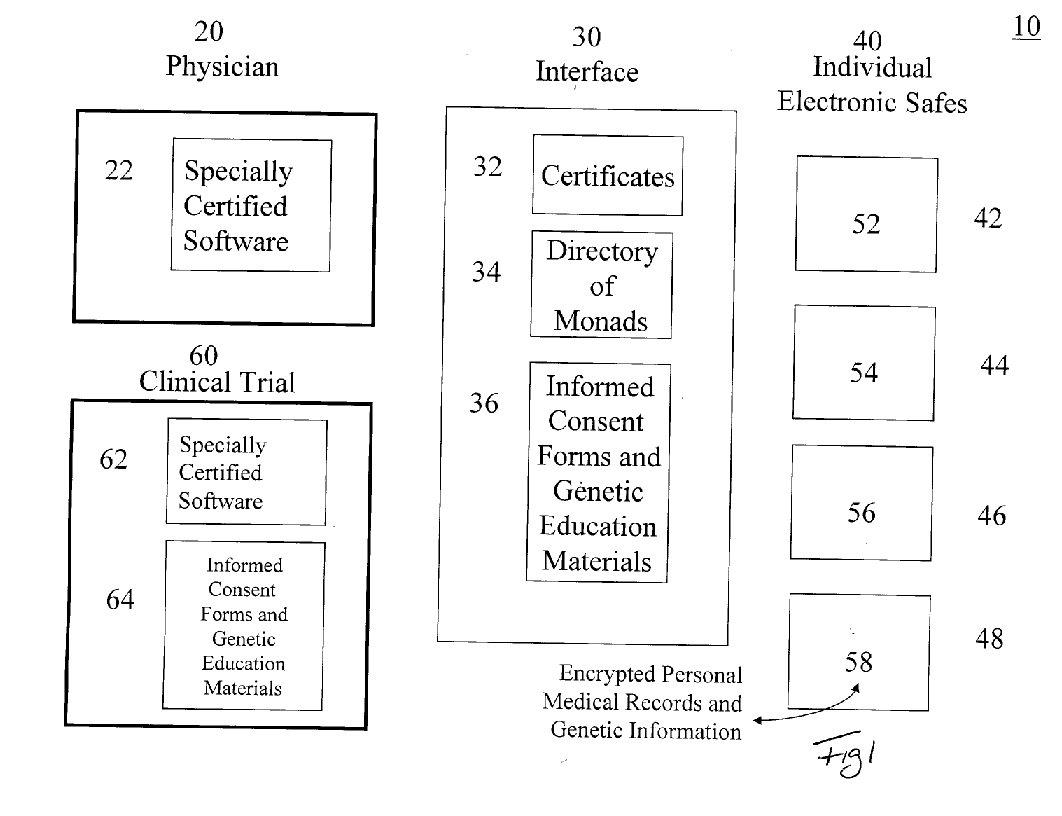

FIG. 1 depicts a personal electronic safe system 10 that includes individual electronic safes 42-48, an interface 30, and physician/clinician certified software systems 20 and 60. The individual electronic safes 42 through 48 each contain an individual's encrypted information stored as monads 52 through 58. Encrypted data may include encrypted medical, genetic, biological, or demographic data, as well as passwords or other keys for accessing sample data or other records. In one embodiment, each individual electronic safe 42 through 48 has an associated URL, and the URL may be anonymous in that it lacks information that may be employed to identify the user or patient associated therewith. Although the systems and methods described herein will employ URLs as reference pointers, it will be apparent to those of skill in the art that other types of references addresses or pointers may be employed and that the reference used will depend at least in part on the application at hand. The interface 30 has a directory 34 which contains the anonymous URLs and certain characteristics associated each of the individual electronic safes. As will be described in greater detail hereinafter, the interface 30 may act, at least in part, as a registry through which the electronic safes 42-48 can be registered to identify themselves to an entity.

Thus, it will be seen that the system 10 depicted in FIG. 1 provides a system for controlling access to genetic and medical data. The system 10 includes a database for storing one or more encrypted data files having information representative of genetic and medical data and being associated with an individual. The system 10 includes an access control processor for allowing the individual to restrict access rights that an entity may have to the encrypted data file associated with the respective individual. In the embodiment of FIG. 1, the access control processor negotiates certificates between the entity and the interface 30. Further, illustrated by FIG. 1 is the message processor for delivering a message from the entity to the individual, whereby the individual can receive messages from an entity without the entity knowing the identity of the individual.

The system depicted in FIG. 1 comprises an embodiment wherein a client/server architecture is employed to support the systems of the invention. For example, the physicians 20 clinicians 60 or other entities may act as client systems that seek services of the interface 30 that acts as a server to these clients. In this particular embodiment, the clients are capable of communicating across the Internet or other data network, including LANs, WANs, and other systems. The client/server architecture illustrated in FIG. 1 is only one embodiment of the systems of the invention, and in other embodiments the system may be realized as a stand alone system, either running on a PC or running within an embedded computer system.

FIG. 1 further depicts that the system 10 includes a certificate based authorization system that controls and/or limits access to the interface 30 to software processes that have been certified or specially certified. Accordingly, in this embodiment a physician, clinician or other entity that wishes to access the interface 30 is to employ certified software that the interface 30 will recognize as authorized. System 10 depicted in FIG. 1 can use any of the conventional certificate based authorization systems for brokering and controlling access between entities and the interface 30. As is known to those who are skilled in the art, a certificate System is merely one way of controlling access to a server or service. As is known digital certificates are electronic identifiers that can be used by individual users, processes or systems to identify and authenticate themselves electronically to other users, systems or processes. These electronic identifiers have certain attributes that enable users and systems to “trust” the certificates and therefore rely on their authenticity. Public and private key systems have been developed for providing certificate based authorization systems and any of these types of systems may be employed with the system 10 and depicted in FIG. 1. Additionally, in other embodiment the system 10 may employ other types of authorization and access control, including password based systems that require a user or entity to submit an authorized password to the interface 30 before the interface 30 will grant the entity access. Other systems and methods for controlling access to the system 30 may be employed without departing from the scope hereof. Further, in other embodiments the system may be implemented without requiring an access or authorization control system.

Accordingly, the entity, such as the physician 20 or the clinician 60 may optionally employ the certified software 22 or 62 respectively as a process that may access the interface 30. Typically the certified software 22 and 62 would access a server executing on or as part of the interface 30. Once the certified software 22 or 62 has accessed the interface 30 then the depicted entity physician 20 or clinician 60 may communicate with the interface 30. As shown in FIG. 1 the communication between the entity and the interface 30 may include delivering data from the entity to the interface. For example as shown in FIG. 1 the clinician 60 may include a set of data 64 such as informed consent forms and genetic education materials and other kinds of information that may be delivered from the entity to the interface 30.

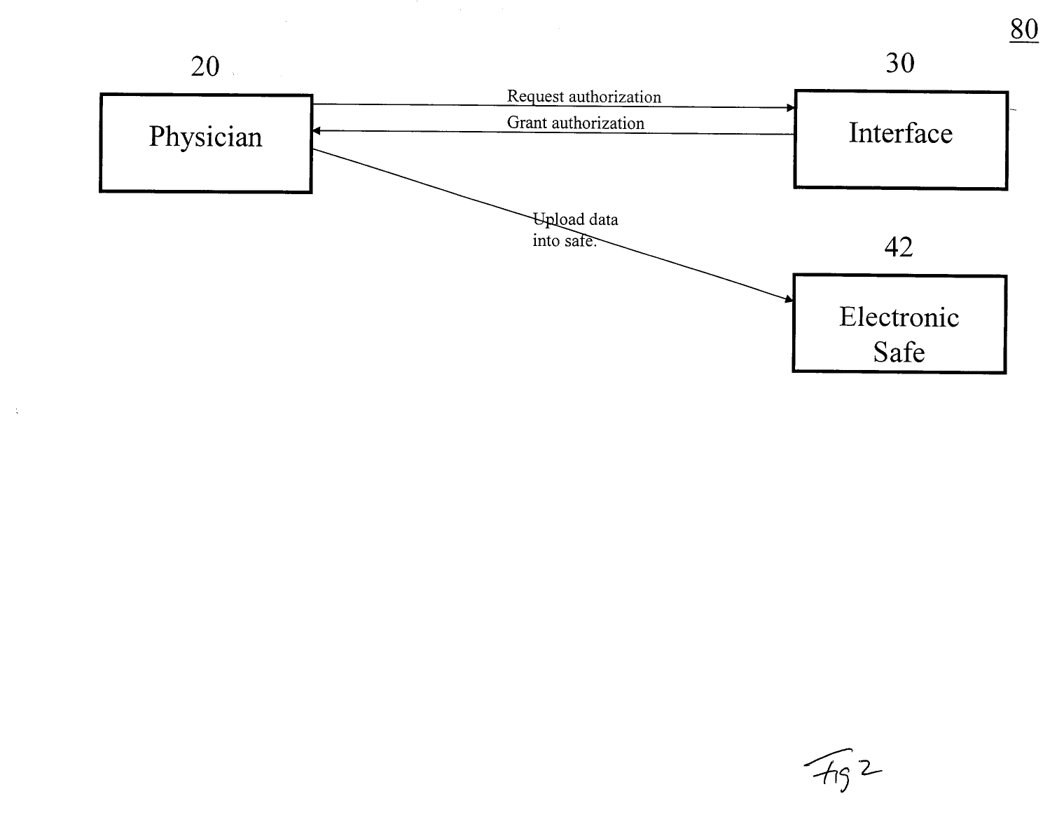

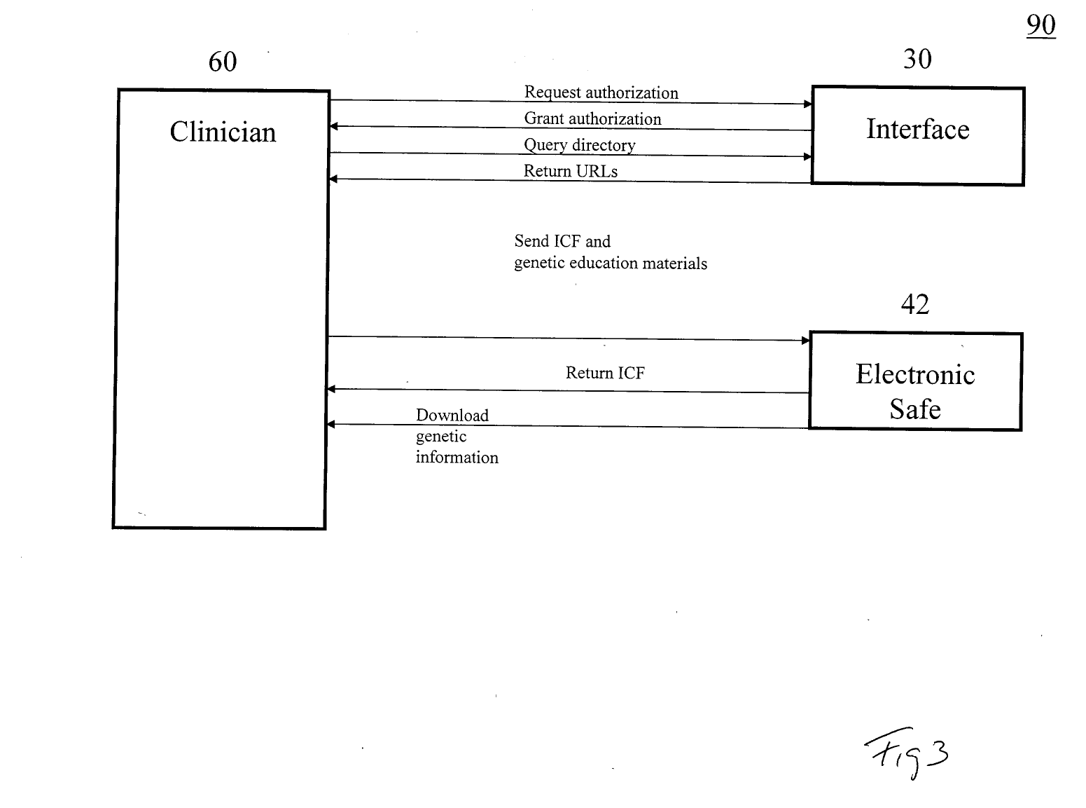

As will be described in greater detail with reference to FIGS. 2 and 3, information 64 delivered from entity 60 to the interface 30 may be associated with a particular monad of data. Each monad registered with the interface 30 may be associated with a particular one of the individual electronic safes 42-48. When information is stored in association with a monad, a flag may set that can be recognized by one of the individual electronic safes or a process associated with one of those safes. The safe or the process may access the interface 30 to collect the information that had been left by the entity for subsequent retrieval by the user or patient associated with the respective monad. In this way the system 10 depicted in FIG. 1 allows for anonymously delivering information from an entity to a user wherein the information delivered may be relevant or targeted to that user as a function of the information the user authorized the entity to view.

FIG. 1 depicts the interface 30 as a functional block element that comprises the certificates 32 the directory of monads 34 and the stored information 36 that includes conformed consent forms and genetic education materials. As discussed above the certificates 32 allow the interface 30 to control access to entities that have been certified to employ the interface 30. The directory of monads 34 is maintained at the interface 30 for providing links or pointers or other information that is representative of a respective monad registered with the interface 30. As further shown in FIG. 1 the interface 30 may have a data base 36 that stores information that has been left by entitles for later retrieval by a patient or user.

The system depicted in FIG. 1 includes elements, such as servers and clients, that can include commercially available systems that have been arranged and modified to act as a system according to the invention.

For example, the client systems can be any suitable computer system such as a PC workstation, a handheld computing device, a wireless communication device, or any other such device, equipped with a network client capable of accessing a network server and interacting with the server to exchange information with the server. In one embodiment, the network client is a web client, such as a web browser that can include the Netscape web browser, the Microsoft Internet explorer web browser, the Lynx web browser, or a proprietary web browser, or web client that allows the user to exchange data with a web server, and ftp server, a gopher server, or some other type of network server. Optionally, the client and the server rely on an unsecured communication path, such as the Internet, for accessing services on the remote server.

To add security to such a communication path, the client and the server can employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Therefore, optionally and preferably, the client systems and the server have built in 128 bit or 40 bit SSL capability and can establish an SSL communication channel between the clients and the server. Other security systems can be employed, such as those described in Bruce Schneir, Applied Crytpography (Addison-Wesley 1996).

The server may be supported by a commercially available server platform such as a Sun Sparc™ system running a version of the Unix operating system and running a server capable of connecting with, or exchanging data with, one of the subscriber systems.

The physician/clinician systems 20 and 60 communicate with the interface 30 via a network to receive authorization, as depicted in FIGS. 2 and 3. The interface 30 may also certify the software used by the physician 20 or clinician 60 to ensure that their software 22 or 62 returns/retrieves only aggregations of medical information, stripped of any identifying information. This may be true even if the returned information was retrieved from only one individual, as this returned information may be stripped of all identity information. When the interface 30 authorizes the physician 20/clinician 60, the physician 20/clinician, in certain practices, may then be allowed to directly update or change the genetic information in the personal electronic safe. However, the amount of control given by the system to the physician may vary according to the application.

When the interface 30 authorizes the clinician 60, the clinician 60 is then allowed to perform a query on the directory 34. The query will return the URLs of the personal electronic safes which have characteristics that fit the query.

The clinician 60 may then send informed consent forms and genetic education materials 64 directly to URLs of the personal electronic safes that were returned by the query. Alternatively, the informed consent forms and genetic education materials 36 may be sent by the interface 30 to the personal electronic safes that were returned by the query. For example, if the query returned the URL for personal electronic safe 42, then the personal electronic safe 42 would receive an informed consent form and genetic education materials from either clinician 60 or the interface 30. If personal electronic safe 42 electronically signs the informed consent form, then the clinician 60 will be granted access to the genetic information 52 stored in the personal electronic safe 42. Thus, the system 10 allows for controlling access to genetic and medical data associated with an individual, but can allow the individual to grant restricted access to the stored data. As depicted and described above, the system 10, in certain embodiments, includes a plurality of data processors 52, 54, . . . , each having a storage device for storing the genetic and medical data of an individual in an encrypted format, 42, 44, . . . A registry interface 30 has storage for a plurality of pointers, wherein a pointer is representative of a respective one of the data processors. The system 10 also includes a query process for allowing an entity 20 or 60 to enter a query representative of a request for information and capable of transmitting the query to the data processors for searching data in the respective encrypted data files. Optionally, the registry includes for each pointer, storage for messages being left by the entity. The messages may include educational material, promotional literature, clinical study information and informed consent forms. Optionally, the system 10 may also include an audit process for creating a log of the entities that have accessed a particular encrypted data file.

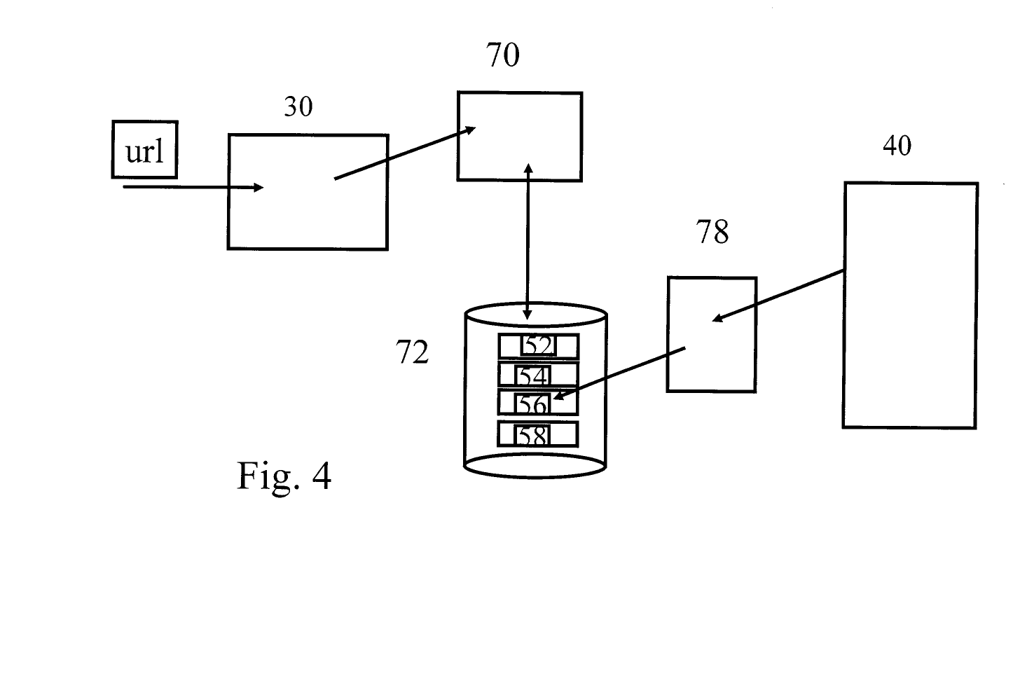

This process for exchanging information is shown in FIG. 4, which illustrates a functional block diagram of the components involved in the exchange and the way data moves during the exchange.

For example, after one of the depicted entities 20 or 60 accesses the interface 30 and employs the certified software 22 or 62 to establish it's authorization to search data that has been presented in the monads, the interface 30, in certain embodiments, will allow the entities 22 or 62 to submit database queries that may be processed by database management system executing at the interface 30 or at some other location to identify monads having information that satisfies the query submitted by the entity 22 or 62. The list of monads that contain the relevant information may be provided to the entity 22 or 62 that submitted the request.

If the entity 22 or 62 wishes to leave information then the entity may submit a pointer, such as a URL that has been provided as representative of the monad by the interface 30 to the entity 20 or 60. As shown in FIG. 4, the URL may be submitted to the interface 30. The interface 30 may parse the URL to determine information within the URL that representative of the monad of interest. As further shown in FIG. 4 the parsing process 70 may then identify the relevant monad 52 to 58 stored within the database 72. If the patient through the process 40 employed the interface 78 to indicate that access would be granted to the information that was relevant to the entity 22 or 62 then the system will allow the entity to access the information stored therein.

The data flow depicted in FIG. 4 further illustrate that the system 10 may include a message processor that has a notification processor for communicating to the individual that a message is waiting for the individual. In one embodiment, the notification processor may include a portal, such as a conventional web portal, that may be accessed by the individual to determine whether a message is waiting for the individual. Further the notification processor may include a mail server for sending an e-mail notification to the individual. Optionally, the notification processor may include a processor for prompting the encrypted data file to notify the respective individual of a waiting message. Once prompted, the individual can access the respective “mailbox” location that stores the information left by the entity, and retrieve the information.

The mailbox, the query process and the data storage process described above may be realized through any suitable database system, including the commercially available Microsoft Access database, and can be a local or distributed database systems. The design and development of suitable database systems are described in McGovern et al., A Guide To Sybase and SQL Server, Addison-Wesley (1993). The databases can be supported by any suitable persistent data memory, such as a hard disk drive, RAID system, tape drive system, floppy diskette, or any other suitable system.

Although FIG. 1 graphically depicts the system by providing a functional block diagram of the different elements that make up the system, it will be apparent to one of ordinary skill in the art that these elements can be realized as computer programs or portions of computer programs that are capable of running on a data processor platform to thereby configure the data processor as a system according to the invention. Thus the system may be realized as a computer program or programs operating on a conventional data processing system such as a Unix workstation. In that embodiment, the mechanism can be implemented as a C language relevant monad 52 to 58 stored within the database 72. If the patient through the process 40 employed the interface 78 to indicate that access would be granted to the information that was relevant to the entity 22 or 62 then the system will allow the entity to access the information stored therein.

The data flow depicted in FIG. 4 further illustrate that the system 10 may include a message processor that has a notification processor for communicating to the individual that a message is waiting for the individual. In one embodiment, the notification processor may include a portal, such as a conventional web portal, that may be accessed by the individual to determine whether a message is waiting for the individual. Further the notification processor may include a mail server for sending an e-mail notification to the individual. Optionally, the notification processor may include a processor for prompting the encrypted data file to notify the respective individual of a waiting message. Once prompted, the individual can access the respective “mailbox” location that stores the information left by the entity, and retrieve the information.

The mailbox, the query process and the data storage process described above may be realized through any suitable database system, including the commercially available Microsoft Access database, and can be a local or distributed database systems. The design and development of suitable database systems are described in McGovern et al., A Guide To Sybase and SQL Server, Addison-Wesley (1993). The databases can be supported by any suitable persistent data memory, such as a hard disk drive, RAID system, tape drive system, floppy diskette, or any other suitable system.

Although FIG. 1 graphically depicts the system by providing a functional block diagram of the different elements that make up the system, it will be apparent to one of ordinary skill in the art that these elements can be realized as computer programs or portions of computer programs that are capable of running on a data processor platform to thereby configure the data processor as a system according to the invention. Thus the system may be realized as a computer program or programs operating on a conventional data processing system such as a Unix workstation. In that embodiment, the mechanism can be implemented as a C language computer program, or a computer program written in any high level language including C++, Fortran, Java or basic. Techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

1. A system for controlling access to genetic and medical data, comprising:
a database for storing an encrypted data file having information representative of genetic and medical data and being associated with an individual,
an access control processor for allowing the individual to restrict access rights that an entity may have to the encrypted data file associated with the respective individual, and
a message processor controlled by the access processor for delivering a message from the entity to the individual, whereby the individual can receive messages from an entity without the entity knowing the identity of the individual.

2. A system according to claim 1, wherein the access control processor includes means for enforcing access restriction controls over the access that the individual may have over the encrypted data file.

3. A system according to claim 2, wherein the access control processor includes means for preventing the individual to access data stored within the encrypted data file.

4. A system according to claim 1, wherein the message processor includes
means for storing a message provided by an interested party third party into a database for later retrieval by the individual.

5. A system according to claim 1, wherein the message processor includes
a notification processor for communicating to the individual that a message is waiting for the individual.

6. A system according to claim 5, wherein the notification processor includes a portal that may be accessed by the individual to determine whether a message is waiting for the individual.

7. A system according to claim 5, wherein the notification processor includes a mail server for sending an e-mail notification to the individual.

8. A system according to claim 5, wherein the notification processor includes a processor for prompting the encrypted data file to notify the respective individual of a waiting message.

9. A system according to claim 1, wherein the access control employs a digital certificates for controlling access to the encrypted data file.

10. A system according to claim 1, wherein the access control processor includes a password verification system for controlling access of to the encrypted data file.

11. A system for allowing a individual to control access to genetic data, comprising
a database system for allowing a individual to create and store a encrypted data file having information representative of genetic data and being associated with a individual and having a set of access rules representative of the parties that may access the genetic information,
a web portal for allowing authorized access to the database, and having
an access control processor for employing the set of access rules to control access by entities to the encrypted data file associated with the respective individual, and
a message processor for delivering a message from an entity to the individual, whereby the individual can receive messages from an entity without the entity knowing the identity of the individual.

12. A process for controlling access to genetic data, comprising:
creating an encrypted data file being associated with a individual and having information representative of genetic and medical data and,
allowing the individual to establish access rights that an entity may have to the encrypted data file associated with the respective individual, and
providing a message processor capable of delivering a message from a third party to the individual, whereby the individual can receive messages from a third party without the third party knowing the identity of the party.

13. A system for controlling access to genetic and medical data, comprising
a plurality of data processors each having a storage device for storing the genetic and medical data of an individual in an encrypted format,
a registry having storage for a plurality of pointers, a pointer being representative of a respective one of said data processors, and
a query process for allowing an entity to enter a query representative of a request for information and being capable of transmitting said query to the plural data processors for searching data in said respective encrypted data files.

14. The system according to claim 13, wherein the registry includes for each pointer storage for messages being left by the entity.

15. The system according to claim 4, wherein the message is selected from the group consisting of educational material, promotional literature, clinical study information and informed consent forms.

16. The system of claim 13 including an audit process for creating a log of the entities that have accessed a particular encrypted data file.
